(19) United States
(12) Patent Application Publication
(10) Pub. No.: US 2013/0094057 A1
(43) Pub. Date: Apr. 18, 2013

(54) IMAGE PROCESSING SYSTEM AND IMAGE PROCESSING APPARATUS

(71) Applicant: Daisuke FUJIKI, Osaka-shi (JP)

(72) Inventor: Daisuke FUJIKI, Osaka-shi (JP)

(73) Assignee: SHARP KABUSHIKI KAISHA, Osaka (JP)

(21) Appl. No.: 13/649,182

(22) Filed: Oct. 11, 2012

(30) Foreign Application Priority Data
Oct. 12, 2011 (JP) 2011-225206

(51) Int. Cl. G06K 15/02

(52) U.S. Cl. 358/1.15

(57) ABSTRACT

In a connection device 2, a limitation step for limiting operations receivable by an operation unit 15 of an image processing apparatus 1 on a step-by-step basis is preset. When the connection device 2 is connected to the image processing apparatus 1, limitation data corresponding to the limitation step is inputted to the image processing apparatus 1 from the connection device 2. When the connection device 2 is connected, the image processing apparatus 1 displays, on a display unit 14, an operation screen that is associated with the limitation data in advance. A special user such as a serviceman conducts special work concerning an operation of the image processing apparatus 1 by utilizing the displayed operation screen. The operation screen necessary for special work is not displayed when the connection device 2 is not connected. A general user who does not use the connection device 2 cannot conduct special work.

### CROSS-REFERENCE TO RELATED APPLICATIONS

This Nonprovisional application claims priority under 35 U.S.C. §119(a) on Patent Application No. 2011-225206 filed in Japan on Oct. 12, 2011, the entire contents of which are hereby incorporated by reference.

### BACKGROUND

1. Technical Field

The present invention relates to: an image processing system including an image processing apparatus provided with a display unit for displaying an operation screen; and an image processing apparatus.

2. Description of Related Art

Currently, image processing apparatuses for performing image processing such as copying are widely used. In particular, an image processing apparatus, e.g., a so-called “multifunction peripheral” provided with a large number of functions such as a print function, a scanner function and a facsimile function, is utilized. Such an image processing apparatus includes: a display unit for displaying an operation screen including a menu necessary for an operation; and an operation unit for receiving an operation performed by a user and corresponding to each type of processing.

In order to allow the image processing apparatus to operate normally, it is necessary to conduct special work concerning operations of the image processing apparatus, such as setting of operating voltages of internal components, updating of programs, and setting of ciphers to be used. When such special work is conducted, a special operation screen is displayed on the display unit, and an operation is performed in accordance with the operation screen. Such special work is conducted by a worker having a necessary skill, such as a serviceman or a worker at the time of fabrication. When such special work is conducted by an unskilled general user, the work might not be conducted properly, and the image processing apparatus might not operate normally. To cope with such a problem, when a general user performs an operation, the image processing apparatus prevents the display unit to display an operation screen necessary for special work. Specifically, when a particular password is inputted or a special operation such as pressing of a plurality of keys in a particular order is performed, the image processing apparatus allows a special operation screen to be displayed on the display unit. Thus, only a particular worker, who knows the password or details of the special operation, allows the special operation screen to be displayed on the display unit to conduct the work.

Further, such an image processing apparatus may be sold in a plurality of countries/regions. However, specifications of the image processing apparatus, such as used languages or operating voltages, might be different among a plurality of countries/regions. When hardware is changed in order to change the specifications of the image processing apparatus, cost problems occur. To cope with such problems, setting of used languages or operating voltages, for example, is changed for each of a plurality of countries/regions, thus changing the specifications of the image processing apparatus. Also when work for making setting is conducted for each of a plurality of countries/regions, only a particular worker, who knows a password or details of a special operation, allows a special operation screen to be displayed on the display unit to perform the work for making the setting.

Furthermore, many of electronic apparatuses are provided with connection interfaces to which external devices are connected and through which data transfer is performed. Some of image processing apparatuses also transfer data to/from external devices via connection interfaces. Examples of such a connection interface include a USB (Universal Serial Bus) connection interface. Japanese Patent Application Laid-Open No. 2010-219531 discloses a USB 3.0 connection interface as an exemplary connection interface.

### SUMMARY OF THE INVENTION

In the image processing apparatus in which a special operation screen is displayed on the display unit by using a password or a special operation, the password or details of the special operation might be leaked. When the password or details of the special operation is/are leaked, an unskilled general user will be able to conduct special work disorderly, and stable operations of the image processing apparatus will not be ensured. Therefore, leakage of the password or details of the special operation has to be prevented, which makes it difficult to operate the image processing apparatus.

The present invention has been made in view of the above-described circumstances, and its object is to provide: an image processing system that enables stable operations of an image processing apparatus by utilizing a connection device; and an image processing apparatus.

In an image processing system according to the present invention including: an image processing apparatus including an operation unit for receiving an operation, and a display unit for displaying an operation screen necessary for the operation; and a connection device to be connected to the image processing apparatus in an attachable and detachable manner. In the connection device, a limitation step for limiting details of operations receivable by the operation unit on a step-by-step basis is preset. The image processing apparatus further includes: a determination section for determining, when the connection device is connected to the image processing apparatus, the limitation step preset in the connection device; and a display control section for displaying, on the display unit, the operation screen corresponding to the limitation step determined by the determination section in a state where the connection device is connected to the image processing apparatus.

In the image processing system according to the present invention, the image processing apparatus further includes a storage section for storing a plurality of operation screen data by which details of a plurality of operation screens are specified, and associating data by which data, corresponding to each of a plurality of limitation steps for limiting details of operations receivable by the operation unit on a step-by-step basis, is associated with one of the plurality of operation screens. In the connection device, data corresponding to one of the plurality of limitation steps is preset. The determination section acquires the data preset in the connection device, thereby determining said one of the limitation steps preset in the connection device. The display control section allows the operation screen, which is associated with the data acquired by the determination section through the associating data, to be displayed on the display unit.

In the image processing system according to the present invention, the image processing apparatus further includes a second display control section for displaying, on the display unit, an operation screen in a state where the connection device is not connected to the image processing apparatus, the operation screen being different from the one displayed in the state where the connection device is connected to the image processing apparatus.

In the image processing system according to the present invention, the image processing apparatus further includes: a USB (Universal Serial Bus) 3.0-compliant connector for connection with the connection device; and a plurality of signal lines connected to the connector, and wherein the determination section acquires the data preset in the connection device through signal lines which are included in the plurality of signal lines but not used in USB 2.0.

In an image processing apparatus according to the present invention including: an operation unit for receiving an operation; a display unit for displaying an operation screen necessary for the operation; a storage section for storing data corresponding to each of a plurality of limitation steps for limiting details of operations receivable by the operation unit on a step-by-step basis; a determination section for acquiring, from outside, data corresponding to one of the plurality of limitation steps, thereby determining said one of the plurality of limitation steps; and a display control section for displaying, on the display unit, the operation screen corresponding to said one of the limitation steps determined by the determination section.

According to the present invention, in the connection device attachable/detachable to/from the image processing apparatus, the limitation step for limiting operations receivable by the operation unit of the image processing apparatus on a step-by-step basis is preset, and the image processing apparatus displays, on the display unit, the operation screen corresponding to the preset limitation step when the connection device is connected to the image processing apparatus. The operation unit of the image processing apparatus receives an operation in accordance with the operation screen displayed on the display unit.

Further, according to the present invention, a plurality of types of operation screens are specified in advance in the image processing apparatus, and the image processing apparatus acquires the data corresponding to the limitation step preset in the connection device and displays, on the display unit, the operation screen associated with the acquired data in advance. The operation screens displayed on the display unit are limited due to differences between the connected connection devices.

Furthermore, according to the present invention, in the state where the connection device is not connected to the image processing apparatus, the image processing apparatus displays, on the display unit, the operation screen different from the one displayed in the state where the connection device is connected to the image processing apparatus. Therefore, when a general user uses the image processing apparatus in the state where the connection device is not connected to the image processing apparatus, the image processing apparatus displays the operation screen for a general user on the display unit.

Moreover, according to the present invention, the connection device is connected to the image processing apparatus via a USB 3.0 interface, and data is inputted to the image processing apparatus from the connection device via the signal lines which are not used in USB 2.0. Thus, the image processing system controls the operation screen by utilizing an existing interface.

In the present invention, a general user, who does not use the connection device used by a serviceman or the like, cannot allow a special operation screen to be displayed on the display unit to conduct special work which should be conducted by a serviceman or the like; hence, a general user is unable to make inappropriate use of the image processing apparatus. Accordingly, the present invention achieves outstanding effects such as facilitation of stable operations of the image processing apparatus.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic diagram illustrating an outer appearance of an image processing system according to the present invention.

FIG. 2 is a block diagram illustrating internal functional configurations of an image processing apparatus and a connection device according to the present invention.

FIG. 3 is a schematic diagram illustrating exemplary details of associating data.

FIG. 4 is a flow chart illustrating a procedure of processing carried out by the image processing apparatus when an operation screen is displayed.

FIG. 5 is a schematic diagram schematically illustrating differences among a plurality of types of operation screens.

### DETAILED DESCRIPTION

Hereinafter, the present invention will be specifically described with reference to the drawings illustrating an embodiment thereof.

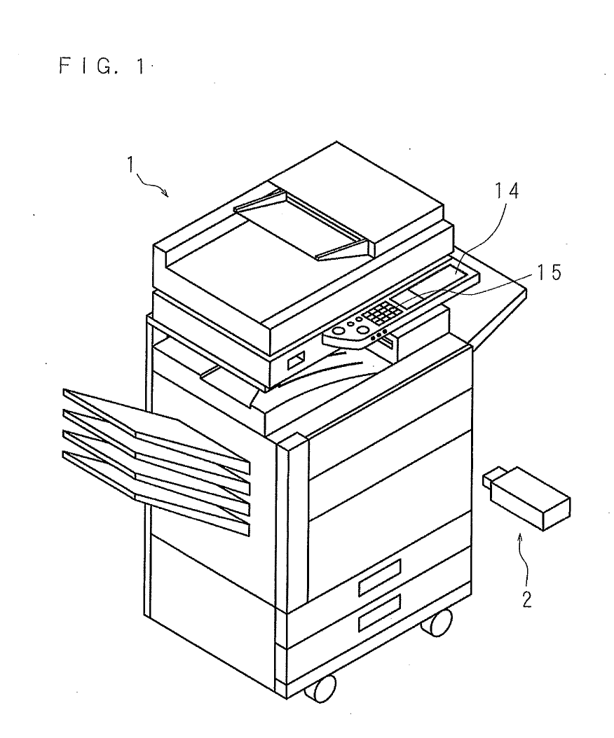

FIG. 1 is a schematic diagram illustrating an outer appearance of an image processing system according to the present invention. The image processing system according to the present invention includes: an image processing apparatus 1 such as a multifunction peripheral; and a connection device 2 attachable/detachable to/from the image processing apparatus 1. The image processing apparatus 1 includes: an operation unit 15 which includes a numeric keypad or the like and receives an operation performed by a user; and a display unit 14 for displaying an operation screen including a menu necessary for the operation unit 15 to receive an operation. The display unit 14 is formed by a liquid crystal panel, for example. Note that the operation unit 15 may be partially or entirely integrated with the display unit 14; for example, in that case, the operation unit 15 may be formed by using a touchscreen.

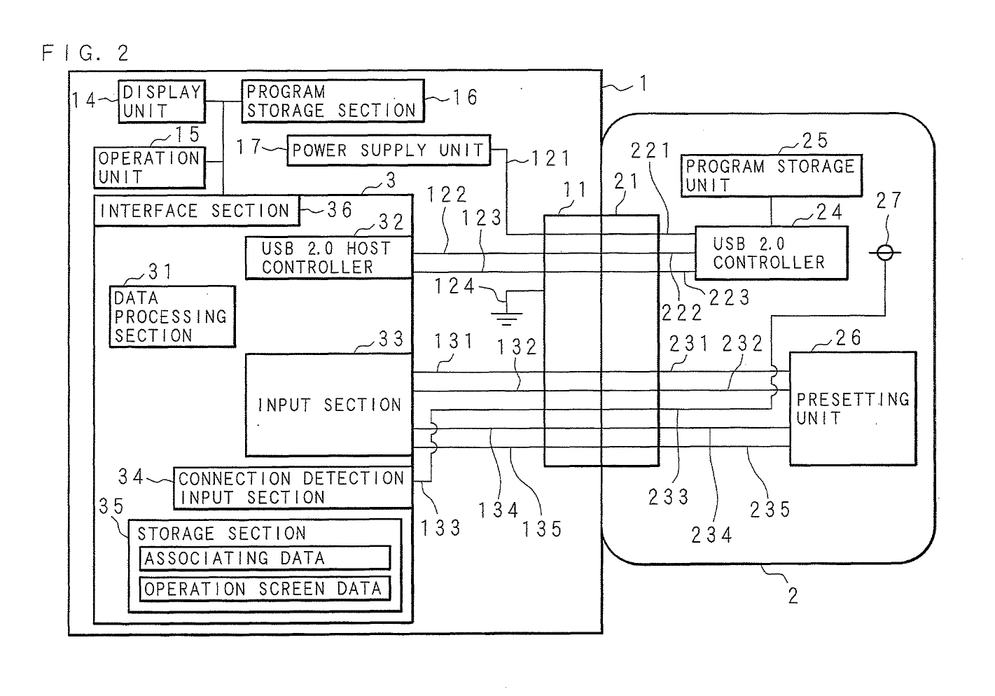

FIG. 2 is a block diagram illustrating internal functional configurations of the image processing apparatus 1 and the connection device 2. The image processing apparatus 1 includes a USB (Universal Serial Bus) 3.0 receptacle 11 serving as a connector to which the connection device 2 is to be connected. The USB 3.0 receptacle 11 is a USB 3.0-compliant connector serving as an interface through which data is inputted and outputted. A USB 3.0 interface is an interface through which data is inputted and outputted by using nine signal lines, and therefore, nine signal lines are connected to the USB 3.0 receptacle 11. Further, USB 3.0 has backward compatibility with USB 2.0. A USB 2.0 interface is an interface through which data is inputted and outputted by using four signal lines. Of the nine signal lines connected to the USB 3.0 receptacle 11, four of them are used in USB 2.0. The four signal lines used in USB 2.0 are: a power line 121; two signal lines 122 and 123; and a ground line 124. The power line 121 is connected to a power supply unit 17 for supplying power to the connection device 2 connected to the USB 3.0 receptacle 11. The nine signal lines connected to the USB 3.0 receptacle 11 further include five signal lines 131, 132, 133, 134 and 135 which are not used in USB 2.0.

The image processing apparatus 1 further includes a microcontroller 3. The microcontroller 3 is formed to include: a data processing section 31 for carrying out data processing in accordance with a program; a USB 2.0 host controller 32; and a storage section 35 formed by a nonvolatile memory. The signal lines 122 and 123 are connected to the USB 2.0 host controller 32.

The microcontroller 3 further includes an input section 33 to which signals from the connection device 2 are inputted. Of the five signal lines which are not used in USB 2.0, the signal lines 131, 132, 134 and 135 are connected to the input section 33. The microcontroller 3 further includes a connection detection input section 34 to which the remaining signal line 133 is connected. The signal line 133 is a signal line used as a ground line in a normal USB 3.0 interface. In the present invention, the signal line 133 is utilized to detect connection of the connection device 2. The microcontroller 3 further includes an interface section 36. The interface section 36 is connected with: the display unit 14; the operation unit 15; and a program storage section 16 serving as a memory for storing a program necessary for the data processing section 31 to carry out data processing. The microcontroller 3 includes an unillustrated memory for storing temporary data resulting from data processing carried out by the data processing section 31. Moreover, the microcontroller 3 is connected with various unillustrated devices necessary for the image processing apparatus 1 to carry out various processes as an image forming apparatus; for example, the unillustrated devices include: an image reading unit for optically reading a document image to generate image data; and an image forming unit for forming an image based on the image data.

The connection device 2 includes a USB 3.0 plug 21 serving as a connector for connection with the USB 3.0 receptacle 11. The USB 3.0 plug 21 is a USB 3.0-compliant connector. The USB 3.0 plug 21 is connected with: a power line 221; signal lines 222 and 223; and five signal lines 231, 232, 233, 234 and 235 which are not used in USB 2.0. The connection device 2 includes a USB 2.0 controller 24 for performing processing for a USB 2.0 device, and the USB 2.0 controller 24 is connected with the power line 221 and the signal lines 222 and 223. The USB 2.0 controller 24 is further connected with a program storage unit 25 for storing a program by which the program stored in the program storage section 16 is rewritten. The image processing apparatus 1 is capable of performing an updating process by which the program stored in the program storage section 16 is rewritten by the program stored in the program storage unit 25. The program storage unit 25 is a nonvolatile memory. Note that in an alternative mode, the connection device 2 does not include the program storage unit 25.

The connection device 2 further includes a presetting unit 26 that presets a limitation step for limiting details of operations receivable by the operation unit 15 on a step-by-step basis, with the connection device 2 connected to the image processing apparatus 1. The presetting unit 26 is connected with the signal lines 231, 232, 234 and 235. The presetting unit 26 presets the potential of each of the signal lines 231, 232, 234 and 235 at a high or low level, thereby presetting one of a plurality of limitation steps. A combination of the potentials of the respective signal lines 231, 232, 234 and 235, preset in the presetting unit 26, serves as limitation data corresponding to one of the limitation steps. For example, the presetting unit 26 presets the limitation step in order to limit details of operations, receivable by the operation unit 15, to those of operations performed by a serviceman or those of operations performed by a worker at the time of fabrication. The signal lines 231, 232, 234 and 235 are contained inside the presetting unit 26 by soldering, thus presetting the potentials of the respective signal lines. Accordingly, the limitation data preset in the presetting unit 26 cannot be changed, and the limitation step is fixed. Furthermore, the signal line 233 connected to the USB 3.0 plug 21 is connected to a high level potential source 27. When the connection device 2 is connected to the image processing apparatus 1, the limitation data consisting of a combination of high and/or low potentials is inputted to the image processing apparatus 1.

The USB 3.0 plug 21 is connected to the USB 3.0 receptacle 11, thereby connecting the connection device 2 to the image processing apparatus 1. Connection pins provided inside the USB 3.0 receptacle 11 and the USB 3.0 plug 21 are located so that when the USB 3.0 plug 21 is connected to the USB 3.0 receptacle 11, the power line 221 is connected to the power line 121, and the signal lines 222 and 223 are connected to the signal lines 122 and 123, respectively. Similarly, the connection pins are located so that the signal lines 231, 232, 233, 234 and 235 are connected to the signal lines 131, 132, 133, 134 and 135, respectively. In other words, with the connection device 2 connected to the image processing apparatus 1, the USB 2.0 host controller 32 and the USB 2.0 controller 24 are connected to each other via the signal lines 122 and 123 and the signal lines 222 and 223. Further, power will be supplied to the USB 2.0 controller 24 from the power supply unit 17 via the power lines 121 and 221. Furthermore, the presetting unit 26 is connected to the input section 33 via the signal lines 131, 132, 134 and 135 and the signal lines 231, 232, 234 and 235. Accordingly, when the connection device 2 is connected to the image processing apparatus 1, the limitation data from the presetting unit 26 is inputted to the input section 33. In addition, the high level potential source 27 is connected to the connection detection input section 34 via the signal lines 133 and 233.

The storage section 35 included in the microcontroller 3 stores operation screen data indicative of operation screens to be displayed on the display unit 14. Based on the operation screen data stored in the storage section 35, the microcontroller 3 allows the operation screen including a menu to be displayed on the display unit 14. The storage section 35 stores a plurality of pieces of operation screen data such as: operation screen data indicative of an operation screen to be used by a general user; and operation screen data indicative of an operation screen to be used by a serviceman. The storage section 35 further stores associating data by which the limitation data, corresponding to each of a plurality of the limitation steps for limiting details of operations receivable by the operation unit 15 on a step-by-step basis, is associated with the operation screen that should be displayed on the display unit 14.

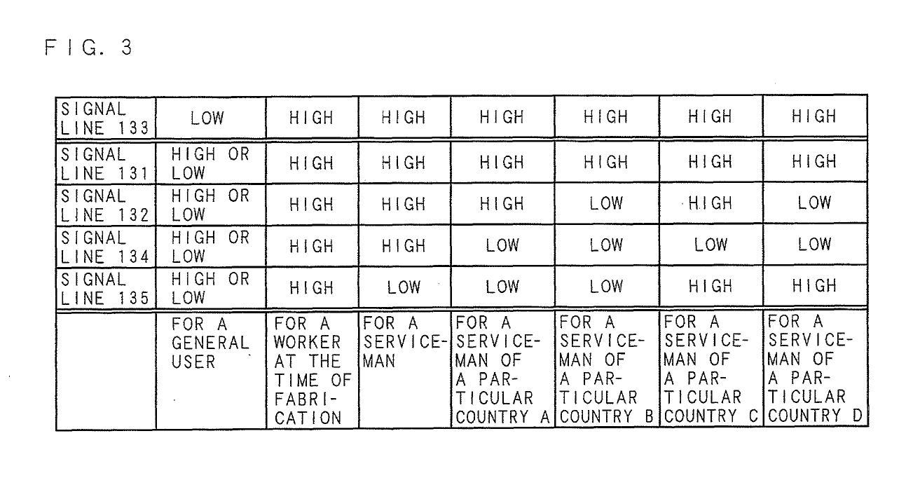

FIG. 3 is a schematic diagram illustrating exemplary details of the associating data. In the associating data, the limitation data corresponding to each of the plurality of limitation steps is recorded. The limitation data consists of combinations of states in which the potentials of the signal lines 131, 132, 134 and 135 connected to the input section 33 are each at a high or low level. It is to be noted that the state in which the potential of the signal line 133 connected to the connection detection input section 34 is at a low level means the state in which the signal line 233 is not connected to the signal line 133 and the connection device 2 is not connected to the image processing apparatus 1. Irrespective of description of the limitation data, the state in which the potential of the signal line 133 is at a low level is associated with the operation screen for a general user.

The state in which the potential of the signal line 133 connected to the connection detection input section 34 is at a high level means the state in which the signal line 233 is connected to the signal line 133 and the connection device 2 is connected to the image processing apparatus 1. In the associating data, the limitation data, in which the potentials of the signal lines 131, 132, 134 and 135 are all at a high level when the potential of the signal line 133 is at a high level, is associated with the operation screen for a worker at the time of fabrication. Further, the limitation data, in which, the potentials of the signal lines 131, 132 and 134 are at a high level and the potential of the signal line 135 is at a low level when the potential of the signal line 133 is at a high level, is associated with the operation screen for a serviceman. Furthermore, the limitation data, in which the potentials of the signal lines 131 and 132 are at a high level and the potentials of the signal lines 134 and 135 are at a low level when the potential of the signal line 133 is at a high level, is associated with the operation screen for a serviceman of a particular country A. Moreover, the limitation data, in which the potential of the signal line 131 is at a high level and the potentials of the signal lines 132, 134 and 135 are at a low level when the potential of the signal line 133 is at a high level, is associated with the operation screen for a serviceman of a particular country B. In addition, the limitation data, in which the potentials of the signal lines 131, 132 and 135 are at a high level and the potential of the signal line 134 is at a low level when the potential of the signal line 133 is at a high level, is associated with the operation screen for a serviceman of a particular country C. Besides, the limitation data, in which the potentials of the signal lines 131 and 135 are at a high level and the potentials of the signal lines 132 and 134 are at a low level when the potential of the signal line 133 is at a high level, is associated with the operation screen for a serviceman of a particular country D. The particular countries A, B, C and D are different countries where the image processing apparatus 1 is used. Note that the details of the associating data illustrated in FIG. 3 are provided by way of example, and relationships between the limitation data and the operation screens may be varied.

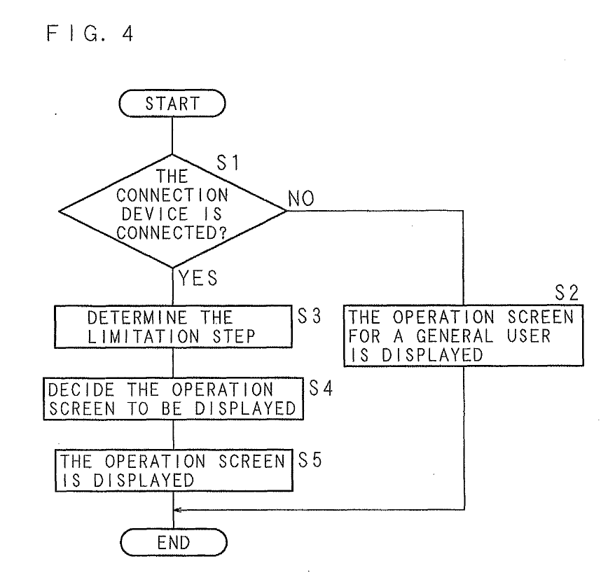

Next, operations of the image processing system will be described. FIG. 4 is a flow chart illustrating a procedure of processing carried out by the image processing apparatus 1 when the operation screen is displayed. First, the data processing section 31 of the microcontroller 3 detects the potential of the signal line 133 connected to the connection detection input section 34, and determines, based on the detected potential, whether or not the connection device 2 is connected to the image processing apparatus 1 (S1). In Step S1, the data processing section 31 determines that the connection device 2 is connected when the potential of the signal line 133 is at a high level, and determines that the connection device 2 is not connected when the potential of signal line 133 is at a low level. When the connection device 2 is not connected to the image processing apparatus 1 (S1: NO), the data processing section 31 reads, from the storage section 35, the operation screen data indicative of the operation screen for a general user, and allows the operation screen for a general user to be displayed on the display unit 14 based on the read operation screen data (S2). The operation screen for a general user is specified in advance so that details of operations receivable by the operation unit 15 are more limited compared with those of operations receivable by the operation unit 15 when the connection device 2 is connected to the image processing apparatus 1.

When the connection device 2 is connected to the image processing apparatus 1 (S1: YES), the data processing section 31 determines the limitation step that is preset in the presetting unit 26 in order to limit details of operations receivable by the operation unit 15 (S3). The signal lines 131, 132, 134 and 135 are connected to the signal lines 231, 232, 234 and 235, thus inputting the limitation data to the input section 33 from the presetting unit 26. In Step S3, the data processing section 31 detects the potentials of the signal lines 131, 132, 134 and 135 connected to the input section 33, thus acquiring the limitation data including a combination of the potentials and determining the limitation step preset in the presetting unit 26. Subsequently, using the associating data stored in the storage section 35, the data processing section 31 determines the operation screen associated with the inputted limitation data, thus deciding the operation screen to be displayed on the display unit 14 (S4). For example, when the potentials of the signal lines 131, 132, 134 and 135 are all at a high level, the data processing section 31 decides that the operation screen to be displayed is the operation screen for a worker at the time of fabrication. Then, the data processing section 31 reads, from the storage section 35, the operation screen data indicative of the determined operation screen, and allows the operation screen to be displayed on the display unit 14 based on the read operation screen data (S5). Note that the image processing apparatus 1 may perform a process for receiving a preset password or special operation by the operation unit 15 before the operation screen is displayed. As a result of Step S5, the operation screen corresponding to the limitation step preset in the presetting unit 26 is displayed on the display unit 14.

After Step S2 or S5 has been finished, the image processing apparatus 1 ends the processing for displaying the operation screen. Subsequently, the image processing apparatus 1 receives, at the operation unit 15, an operation performed by a user who has visually recognized the operation screen displayed on the display unit 14, and carries out processing in response to the received operation. In one example, the image processing apparatus 1 performs image processing in response to the received operation. In another example, the image processing apparatus 1 makes various necessary settings in response to the received operation. In still another example, in response to the received operation, the image processing apparatus 1 reads the program stored in the program storage unit 25 to carry out a process for updating the program stored in the program storage section 16.

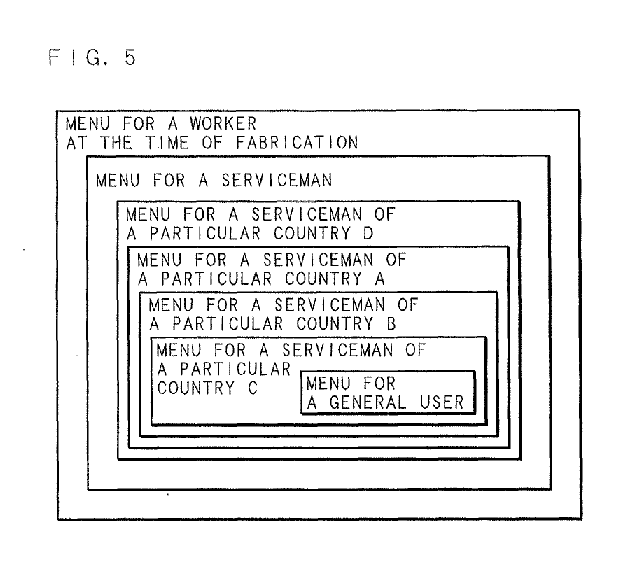

The operation screen displayed on the display unit 14 includes a menu necessary for the operation unit 15 to receive an operation. FIG. 5 is a schematic diagram schematically illustrating differences among a plurality of types of operation screens. A menu included in the operation screen for a worker at the time of fabrication is a menu that allows the operation unit 15 to receive the largest number of operations. For example, the display unit 14 displays a menu for carrying out work directly concerning an operation of each circuit of the image processing apparatus 1, such as clearing of the memory included in the microcontroller 3 or program updating. Operations receivable by the operation unit 15 through a menu included in the operation screen for a serviceman are more limited compared with those receivable by the operation unit 15 through the menu for a worker at the time of fabrication. For example, the display unit 14 displays a menu for receiving an operation necessary for program updating, but does not display a menu for receiving an operation necessary for clearing of the memory.

Furthermore, operations receivable by the operation unit 15 through a menu included in the operation screen for a serviceman of the particular country D are more limited compared with those receivable by the operation unit 15 through the menu for a serviceman of the home country. Similarly, operations receivable by the operation unit 15 through a menu included in the operation screen for a serviceman of the particular country A are more limited than those receivable by the operation unit 15 through the menu for a serviceman of the particular country D. Operations receivable by the operation unit 15 through a menu included in the operation screen for a serviceman of the particular country B are more limited than those receivable by the operation unit 15 through the menu for a serviceman of the particular country A. Operations receivable by the operation unit 15 through a menu included in the operation screen for a serviceman of the particular country C are more limited than those receivable by the operation unit 15 through the menu for a serviceman of the particular country B. Moreover, operations receivable by the operation unit 15 through a menu included in the operation screen for a general user are more limited compared with those receivable by the operation unit 15 through the menu for a serviceman of the particular country C. In the menus for servicemen of the respective countries, for example, menus for settings of used languages, types of usable ciphers or settings of operating voltages of components are different.

Since the menus included in the operation screens displayed on the display unit 14 are different from each other, details of operations receivable by the operation unit 15 are varied accordingly, and processes carried out by the image processing apparatus 1 in response to the received operations are varied. Details of the operation screens are varied through a plurality of steps, thus limiting details of operations receivable by the operation unit 15 on a step-by-step basis. Note that FIG. 5 illustrates the example in which details of one of the operation screens are included in some of the other operation screens, but in an alternative mode, no common details are included in the plurality of types of operation screens.

As described in detail thus far, when the connection device 2 is not connected to the image processing apparatus 1, the image processing apparatus 1 allows the operation screen for a general user to be displayed on the display unit 14, and when the connection device 2 is connected to the image processing apparatus 1, the image processing apparatus 1 allows the operation screen, corresponding to the limitation step preset in the presetting unit 26, to be displayed on the display unit 14. The operation unit 15 receives an operation in accordance with the operation screen displayed on the display unit 14, and the image processing apparatus 1 carries out processing in response to the received operation. Therefore, operations receivable by the operation unit 15 are limited in accordance with the limitation step preset in the presetting unit 26 of the connection device 2, thereby limiting details of processing that can be carried out by the image processing apparatus 1. For example, in the presetting unit 26 of the connection device 2 for a serviceman, the limitation step is preset so that an operation for work which should be conducted by a serviceman is receivable by the operation unit 15. A serviceman connects the connection device 2 for a serviceman to the image processing apparatus 1, and thus can conduct work that should be conducted by a serviceman, by allowing the operation screen for a serviceman to be displayed on the display unit 14. For example, a serviceman can conduct work which allows the image processing apparatus 1 to carry out program updating. The connection device 2 for a serviceman is managed by a serviceman and cannot be used by a general user. A general user cannot use the connection device 2 for a serviceman and thus cannot allow the operation screen for a serviceman to be displayed on the display unit 14 and perform an operation that should be performed by a serviceman. Accordingly, a general user cannot conduct special work that should be conducted by a serviceman, e.g., carrying out of program updating by the image processing apparatus 1. Similarly, a general user cannot conduct work that should be conducted by a worker at the time of fabrication.

Since a general user cannot conduct special work that should be conducted by a serviceman or the like, it is impossible for a general user to make inappropriate use of the image processing apparatus 1 such as disorderly execution of special work by a general user, thus enabling stable operations of the image processing apparatus 1. Further, the necessity to manage a password or special operation in order to prevent inappropriate use of the image processing apparatus 1 is eliminated, and the image processing apparatus 1 will be operated with ease.

Furthermore, in the present invention, the limitation step is preset in the presetting unit 26 of the connection device 2 for a serviceman for each country, in which the image processing apparatus 1 is used, so that an operation for work which should be conducted by a serviceman of each country is receivable by the operation unit 15. A serviceman of each country connects the connection device 2 for a serviceman of each country to the image processing apparatus 1, thereby allowing the operation screen for a serviceman of each country to be displayed on the display unit 14 and allowing a serviceman of each country to conduct work that should be done, such as setting of used language. Thus, setting work is conducted for each of a plurality of countries/regions, thereby making it possible to easily change specifications of the image processing apparatus 1 for each of a plurality of countries/regions.

Moreover, the connection device 2 is connected to the image processing apparatus 1 via a USB 3.0 interface, and the limitation data is inputted to the image processing apparatus 1 from the connection device 2 via the signal lines which are not used in USB 2.0. For connection of the connection device 2, the present invention uses a general interface instead of using any special interface, thus making it possible to reduce fabrication costs of the image processing apparatus 1 and the connection device 2. In addition, an external apparatus that utilizes USB 2.0 can be connected to the USB 3.0 receptacle 11, and the image processing apparatus 1 can exchange data with the external apparatus; hence, the circuits provided within the image processing apparatus 1 can be effectively utilized.

Note that the mode in which the potentials of the signal lines 231, 232, 234 and 235 are each preset in the presetting unit 2 is provided in the present embodiment; however, in an alternative mode, the presetting u nit 26 may be formed by a memory for storing data indicative of limitation steps. In this mode, when the connection device 2 is connected to the image processing apparatus 1, the microcontroller 3 performs a process for reading the data stored in the presetting unit 26. In this mode, from among a larger number of limitation steps, one limitation step can be selected and preset. Furthermore, in the present embodiment, the mode in which data processing necessary for the image processing apparatus 1 is mainly carried out by the microcontroller 3 is provided. However, in an alternative mode, the image processing apparatus 1 may include, instead of the microcontroller 3, a plurality of information processing circuits for carrying out equivalent data processing in a distributed manner.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image processing system comprising:
an image processing apparatus including an operation unit for receiving an operation, and a display unit for displaying an operation screen necessary for the operation; and
a connection device to be connected to the image processing apparatus in an attachable and detachable manner,
wherein in the connection device, a limitation step for limiting details of operations receivable by the operation unit on a step-by-step basis is preset, and
wherein the image processing apparatus further includes:
a determination section for determining, when the connection device is connected to the image processing apparatus, the limitation step preset in the connection device; and
a display control section for displaying, on the display unit, the operation screen corresponding to the limitation step determined by the determination section in a state where the connection device is connected to the image processing apparatus.

2. The image processing system according to claim 1,
wherein the image processing apparatus further includes a storage section for storing a plurality of operation screen data by which details of a plurality of operation screens are specified, and associating data by which data, corresponding to each of a plurality of limitation steps for limiting details of operations receivable by the operation unit on a step-by-step basis, is associated with one of the plurality of operation screens,
wherein in the connection device, data corresponding to one of the plurality of limitation steps is preset,
wherein the determination section acquires the data preset in the connection device, thereby determining said one of the limitation steps preset in the connection device, and
wherein the display control section allows the operation screen, which is associated with the data acquired by the determination section through the associating data, to be displayed on the display unit.

3. The image processing system according to claim 2,
wherein the image processing apparatus further includes a second display control section for displaying, on the display unit, an operation screen in a state where the connection device is not connected to the image processing apparatus, the operation screen being different from the one displayed in the state where the connection device is connected to the image processing apparatus.

4. The image processing system according to claim 2,
wherein the image processing apparatus further includes:
a USB (Universal Serial Bus) 3.0-compliant connector for connection with the connection device; and
a plurality of signal lines connected to the connector, and
wherein the determination section acquires the data preset in the connection device through signal lines which are included in the plurality of signal lines but not used in USB 2.0.

5. An image processing apparatus comprising:
an operation unit for receiving an operation;
a display unit for displaying an operation screen necessary for the operation;
a storage section for storing data corresponding to each of a plurality of limitation steps for limiting details of operations receivable by the operation unit on a step-by-step basis;
a determination section for acquiring, from outside, data corresponding to one of the plurality of limitation steps, thereby determining said one of the plurality of limitation steps; and
a display control section for displaying, on the display unit, the operation screen corresponding to said one of the limitation steps determined by the determination section.
